(19) United States
(12) Patent Application Publication
(10) Pub. No.: US 2012/0042740 A1
(43) Pub. Date: Feb. 23, 2012

(54) LINEAR MOTION MECHANISM AND ROBOT

(75) Inventor: Toru ISOBE, Toyota-shi (JP)

(73) Assignee: TOYOTA JIDOSHA KABUSHIKI KAISHA, Toyota-shi (JP)

(21) Appl. No.: 13/215,708

(22) Filed: Aug. 23, 2011

Related U.S. Application Data
(63) Continuation of application No. PCT/JP2010/005178, filed on Aug. 23, 2010.

(51) Int. Cl. F16H 25/12

(52) U.S. Cl. 74/89

(57) ABSTRACT

To provide a linear motion mechanism and a robot in which when a magnetic joint is disengaged, the joint relation of the magnetic joint can be easily restored. A linear motion mechanism includes a movable part that receives a reaction force from a guild disposed in one axis direction, and moves along the guide, a sliding part that slides along the guides, a magnetic joint that magnetically joins the movable part to the sliding part, and a restoration member that restores a joint relation between the movable part and the sliding part.

This is a continuation of International Application PCT/JP2010/005178, with an international filing date of Aug. 23, 2010, which is hereby incorporated by reference herein its entirety.

### TECHNICAL FIELD

The present invention relates to a linear motion mechanism and a robot.

### BACKGROUND ART

As disclosed in Patent literatures 1 and 2, for example, linear motion mechanisms using magnetic joints have been known. In particular, in the linear motion mechanism disclosed in Patent literature 1, a pinion is provided on a rotation shaft from which a blind is suspended and supported. A vertically-disposed rack is engaged with the pinion. An inner-side magnet, which constitutes one part of the magnetic joint, is provided in the rack. An outer-side magnet, which constitutes the other part of the magnetic joint, is disposed so as to be opposed to the inner-side magnet. The outer-side magnet is vertically moved by a drive device. When the outer-side magnet is vertically moved by driving the drive device, the inner-side magnet is magnetically attracted and thereby vertically moved. In this way, the rack is vertically moved and the pinion is thereby rotated. As a result, the rotation shaft rotates and therefore the blind opens/closes.

### CITATION LIST

### Patent Literature

Patent literature 1: Japanese Unexamined Patent Application Publication No. 7-91153
Patent literature 2: Japanese Patent No. 2635226

### SUMMARY OF INVENTION

### Technical Problem

In the linear motion mechanism disclosed in Patent literature 1, if an excessive load is exerted on the inner-side magnet or on the outer-side magnet, their mutual joint relation is broken. When this happened, it is necessary to perform a readjustment process of the origin point or a similar process to restore the joint relation between the inner-side magnet and the outer-side magnet. Therefore, it requires a complicated process after the joint relation between the inner-side magnet and the outer-side magnet is broken.

The present invention has been made to solve such problems, and an object thereof is to provide a linear motion mechanism and a robot in which when the magnetic joint is disengaged, the joint relation of the magnetic joint can be easily restored.

### Solution to Problem

A linear motion mechanism in accordance with the present invention includes: a movable part that receives a reaction force from a guild disposed in one axis direction, and moves along the guide; a sliding part that slides along the guides; a magnetic joint that magnetically joins the movable part to the sliding part; and a restoration member that restores a joint relation between the movable part and the sliding part. In this way, even if the magnetic joint is disengaged, the joint relation of the magnetic joint can be easily restored again by the restoration member. Therefore, in the linear motion mechanism, the joint relation of the magnetic joint can be easily restored.

A reaction force transmission part is preferably formed in the sliding part with a space in the one axis direction; the movable part is preferably disposed in the space portion of the reaction force transmission part; and the restoration member is preferably disposed between the reaction force transmission part and the movable part.

The linear motion mechanism preferably also includes a restraint mechanism that restrains a rotation of the sliding part around an axis of the guide.

As the magnetic joint, a magnet is preferably provided in one of the movable part and the sliding part, a member that is magnetically attracted by the magnet is preferably provided in the other of the movable part and the sliding part; and the magnet and the member that is magnetically attracted by the magnet are preferably disposed so as to be opposed to each other.

The magnetic joint is preferably disposed on both sides of the guide. In this way, it is possible to roughly cancel out the forces that would otherwise cause the movable part to move toward the sliding part side due to the joining force of the magnetic joint.

The linear motion mechanism preferably also includes an assist mechanism that assists the joint relation between the movable part and the sliding part. In this way, the burden on the magnetic joint can be reduced, and therefore the size of the magnetic joint can be reduced.

The linear motion mechanism preferably also includes: a measurement unit that measures a distance in the one axis direction between the movable part and the sliding part; and a control unit that receives a measurement value of the measurement unit, calculates a displacement of the sliding part with respect to the movable part, and when the calculated displacement is equal to or greater than a threshold, stops a movement of the movable part. In this way, the joint relation between the movable part and the sliding part will not be easily disengaged.

A robot in accordance with the present invention includes the above-described linear motion mechanism. In this way, even if the magnetic joint is disengaged, the joint relation of the magnetic joint can be easily restored again by the restoration member. Therefore, the joint relation of the magnetic joint can be easily restored.

### Advantageous Effects of Invention

In accordance with the present invention, it is possible to provide a linear motion mechanism and a robot in which when a magnetic joint is disengaged, the joint relation of the magnetic joint can be easily restored.

### BRIEF DESCRIPTION OF DRAWINGS

FIG. 1 is a partial cross-section schematically showing a robot in accordance with a first exemplary embodiment according to the present invention;

FIG. 2 is a horizontal cross-section schematically showing a linear motion mechanism in accordance with a first exemplary embodiment according to the present invention;

FIG. 3 is a side view schematically showing a part of a linear motion mechanism in accordance with a first exemplary embodiment according to the present invention;

FIG. 4 shows a characteristic between a magnetic joint and a restoration member;

FIG. 5 is a figure for explaining a displacement of a sliding part with respect to a movable part;

FIG. 6 is a block diagram of a control system in a robot in accordance with a first exemplary embodiment according to the present invention;

FIG. 7 shows a configuration of a magnetic joint in a linear motion mechanism in accordance with a second exemplary embodiment according to the present invention;

FIG. 8 schematically shows a relation between a movable part and a sliding part in a linear motion mechanism in accordance with a third exemplary embodiment according to the present invention;

FIG. 9 schematically shows a position of a magnetic joint;

FIG. 10 is a front view schematically showing a robot in accordance with a fourth exemplary embodiment according to the present invention;

FIG. 11 is a front view schematically showing a robot in accordance with a fifth exemplary embodiment according to the present invention; and

FIG. 12 is a block diagram of a control system in a robot in accordance with a fifth exemplary embodiment according to the present invention.

### DESCRIPTION OF EMBODIMENTS

### First Exemplary Embodiment

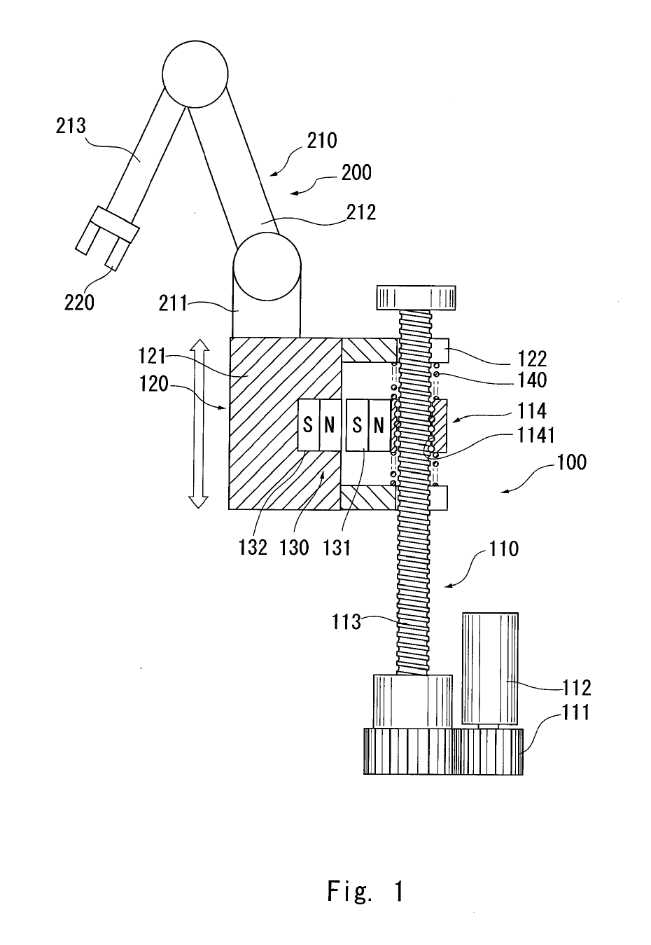

A first exemplary embodiment of a linear motion mechanism and a robot in accordance with the present invention is explained with reference to the drawings. As shown in FIGS. 1 to 3, a robot 1 includes a linear motion mechanism 100 and a robot arm 200. The linear motion mechanism 100 includes a drive mechanism 110, a sliding part 120, a magnetic joint 130, restoration members 140, and a restraint mechanism 150.

The drive mechanism 110 includes a pedestal 111, a drive motor 112, a gear train (not shown), a ball screw nut (guide) 113, and a movable part 114. Specifically, the drive motor 112 is mounted on the pedestal 111. The gear train is housed within the pedestal 111. The ball screw nut 113 is rotatably supported on the pedestal 111. That is, the ball screw nut 113 is disposed in a vertical direction. The rotational driving force of the drive motor 112 is transmitted to the ball screw nut 113 through the gear train.

The movable part 114 has such a thickness that the movable part 114 is not shaken in the vertical direction when the sliding part 120 is moved by means of the magnetic joint 130. As shown in FIG. 1, a through-hole is formed in the vertical direction in the movable part 114. A female thread is formed in this through-hole, and serves as a female thread part 1141. The female thread part 1141 engages with the ball screw nut 113 through a bearing. The movable part 114 includes a first magnetic member (magnet) 131 that constitutes a part of the magnetic joint 130.

The sliding part 120 includes a base part 121 and reaction force transmission parts 122. The base part 121 supports the robot arm 200. The side portion on the movable part 114 side in the base part 121 includes the reaction force transmission parts 122, which are spaced from each other in the vertical direction. The side portion on the movable part 114 side in the base part 121 also includes a second magnetic member (magnet) 132 that constitutes a part of the magnetic joint 130 between the upper and lower reaction force transmission parts 122. Note that a position at which the second magnetic member 132 of the sliding part 120 is opposed to the first magnetic member 131 of the movable part 114 is defined as the origin point of the sliding part 120.

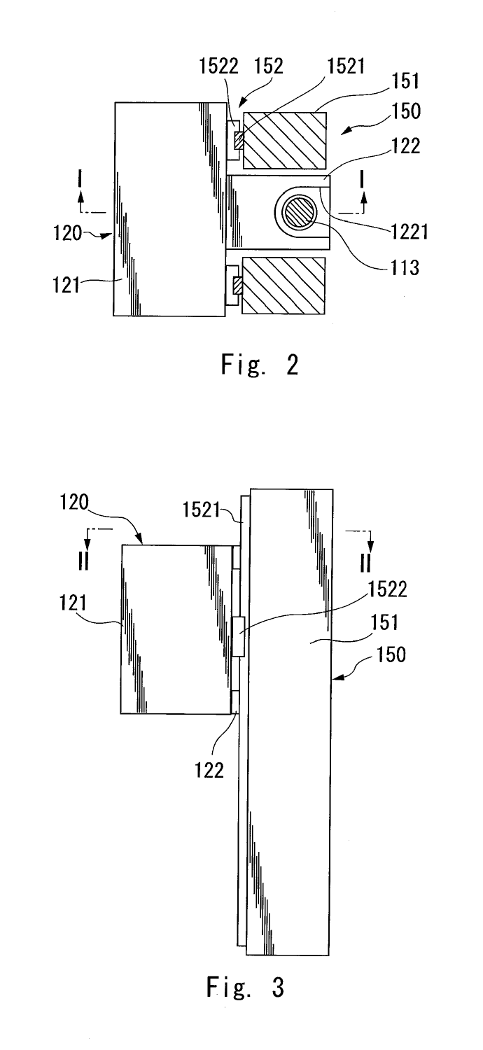

The reaction force transmission parts 122 protrude from the base part 121 roughly horizontally in roughly the same directions. That is, as shown in FIG. 2, the reaction force transmission parts 122 of this exemplary embodiment are disposed in the same plane. One end of each reaction force transmission part 122 is joined to the base part 121. In the other end, a cut-out portion 1221 is formed. The ball screw nut 113 is housed within this cut-out portion 1221. The movable part 114 is disposed in the space portion between the vertically-arranged reaction force transmission parts 122.

As shown in FIG. 1, the magnetic joint 130 includes the first magnetic member 131 and the second magnetic member 132. The first magnetic member 131 is disposed in the side portion of the movable part 114 located on the base part 121 side of the sliding part 120. The second magnetic member 132 is disposed in the side portion of the sliding part 120 located on the movable part 114 side. In this way, when the sliding part 120 is positioned at the origin point, the first magnetic member 131 and the second magnetic member 132 are opposed to each other. The first magnetic member 131 and the second magnetic member 132 exert a magnetic attractive force so that the magnetic joint relation between the sliding part 120 and the movable part 114 is not broken when the robot arm 200 is vertically moved and/or when a load is exerted on the sliding part 120.

Each of the restoration members 140 is an elastic member such as a spring and a rubber. Each of the restoration members 140 is disposed between the movable part 114 and a respective one of the reaction force transmission parts 122 of the sliding part 120. For example, springs are used as the restoration members 140, each spring is placed over the ball screw nut 113 between the movable part 114 and a respective one the reaction force transmission parts 122 of the sliding part 120. The restoration members 140 exert a restoration force that acts to move and return the sliding part 120 to the origin point when the joint relation between the movable part 114 and the sliding part 120 by the magnetic joint 130 is disengaged.

As shown in FIGS. 2 and 3, the restraint mechanism 150 includes support columns 151 and linear rails 152. The support columns 151 are disposed on both sides of the ball screw nut 113 as viewed from the top. The height of the support columns 151 is roughly equal to that of the ball screw nut 113.

Each of the linear rails 152 includes a rail 1521 and a slider 1522. The rail 1521 is disposed on the side of the support column 151 located on the base part 121 side of the sliding part 120. The slider 1522 is disposed on the side of the base part 121 of the sliding part 120 located on the support column 151 side. The slider 1522 is coupled to the rail 1521 in such a manner that the slider 1522 can move in the axis direction along the rail 1521 and that any displacement in the directions other than the axis direction can be restrained. In this way, it is possible to restrain the rotation of the sliding part 120 around the axis of the ball screw nut 113. As a result, since the second magnetic member 132 of the sliding part 120 and the first magnetic member 131 of the movable part 114 are magnetically joined to each other, it is also possible to restrain the rotation of the movable part 114 around the axis of the ball screw nut 113.

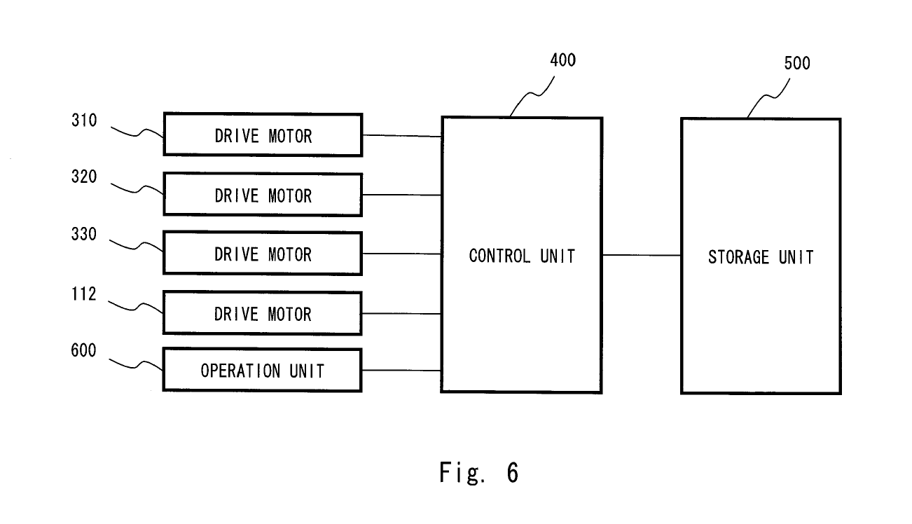

In the linear motion mechanism 100 having the configuration like this, when the drive motor 112 is driven based on a control signal from a control unit 400 (FIG. 6), the rotational driving force of the drive motor 112 is transmitted to the ball screw nut 113 through the gear train. As a result, the ball screw nut 113 rotates and the movable part 114 moves upward or downward. Then, since the movable part 114 and the sliding part 120 are magnetically joined to each other, the sliding part 120 also moves upward or downward as the movable part 114 moves upward or downward. As a result, the robot arm 200 can be moved to a desired height. In this state, if the magnetic joint 130 is disengaged due to an upward or downward load exerted on the sliding part 120 and the sliding part 120 thereby moves in the direction in which the load is exerted, one of the restoration members 140 disposed above or below the movable part 114 contracts. The contracted restoration member 140 exerts a restoration force that acts to push up or push down the sliding part 120 and thereby restores the magnetic joint relation between the movable part 114 and the sliding part 120. As a result, the sliding part 120 returns to the origin point. As described above, even when the magnetic joint is disengaged, the linear motion mechanism 100 can restore the joint relation of the magnetic joint 130 again by the restoration member 140. Therefore, in the linear motion mechanism 100, the joint relation of the magnetic joint 130 can be easily restored.

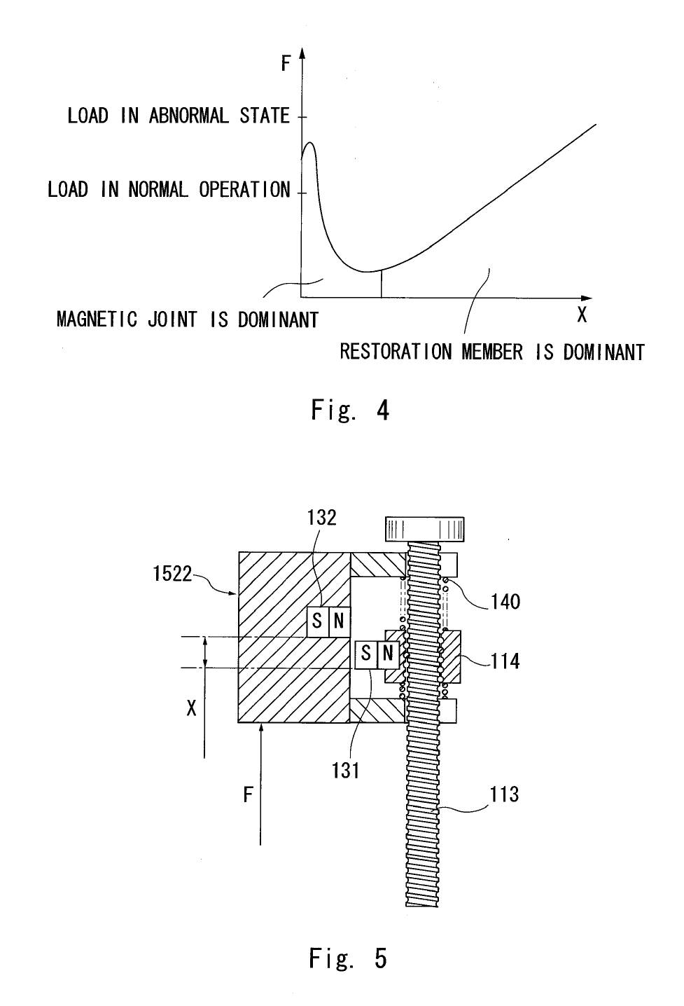

Note that the magnetic joint 130 and the restoration member 140 are preferably adjusted so that the characteristic shown in FIG. 4 is satisfied. Specifically, as shown in FIG. 5, the displacement of the sliding part 120 with respect to the movable part 114 is represented by “X” and the load exerted on the sliding part 120 is represented by “F”.

When the robot arm 200 is moved upward or downward, even if a load larger than the load that is supposed to be exerted on the sliding part 120 is exerted on the sliding part 120, the joint relation of the magnetic joint 130 is maintained. Then, when the load exerted on the sliding part 120 reaches a certain magnitude, the sliding part 120 is gradually pulled away from the movable part 114 and the joint relation of the magnetic joint 130 is weakened. At this point, as the sliding part 120 is pulled away from the movable part 114, the load exerted on the sliding part 120 becomes smaller. However, the joint relation of the magnetic joint 130 also becomes smaller. Eventually, as the joint relation becomes almost zero, the restoration force exerted by the restoration member 140 becomes stronger in proportion to the displacement as a substitute for the magnetic joint.

The robot arm 200 includes a multi-joint arm part 210 and a hand part 220. The arm part 210 of this exemplary embodiment includes a first arm 211, a second arm 212, and a third arm 213. One end of the first arm 211 is connected on the top surface of the base part 121 of the sliding part 120. At the other end of the first arm 211, one end of the second arm 212 is rotatably connected. At the other end of the second arm 212, one end of the third arm 213 is rotatably connected. At the other end of the third arm 213, the hand part 220 is rotatably connected. As shown in FIG. 6, these arms include respective drive motors 310, 320 and 330 at their connection portions (joint portions). Similarly to typical robot hands, the hand part 220 also includes a drive motor (not shown). In this way, they function as a robot arm 200. That is, the control unit 400 shown in FIG. 6 generates a control signal based on a program stored on a storage unit 500 or based on an operation signal from an operation unit 600, and controls the drive motors 310, 320 and 330, the drive motor of the hand part 220, and the drive motor 112 and the like of the linear motion mechanism 100 based on the control signal.

### Second Exemplary Embodiment

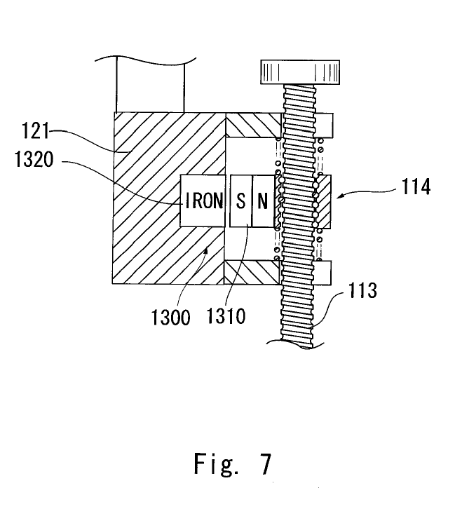

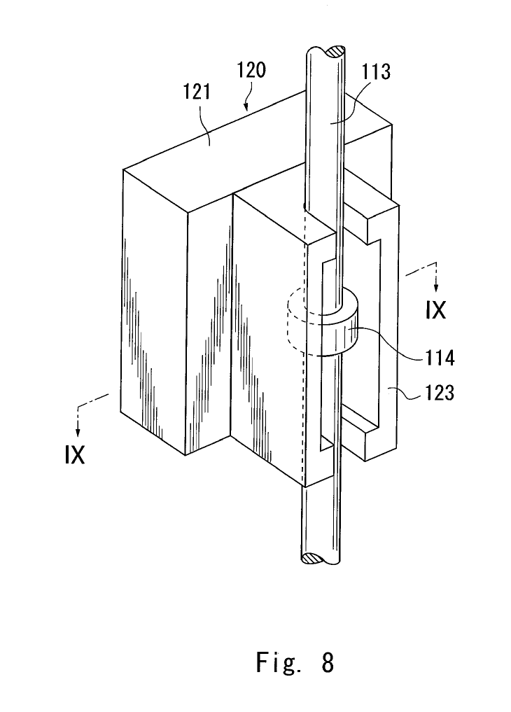

Although the magnetic joint 130 is composed of the first magnetic member 131 and the second magnetic member 132 in the first exemplary embodiment, the present invention is not limited to this configuration. That is, as shown as a magnetic joint 1300 in FIG. 7, the magnetic joint may be composed of a magnetic member 1310 and a member 1320 made of iron or the like that is magnetically attracted by the magnetic member 1310. In this way, inexpensive iron or the like can be used as a substrate for the magnetic member, thus contributing to the reduction in cost. Note that although the magnetic member 1310 is disposed in the movable part 114 and the member 1320 made of iron or the like is disposed in the sliding part 120 in the magnetic joint 1300 shown in FIG. 7, the reversed configuration may be also employed.

### Third Exemplary Embodiment

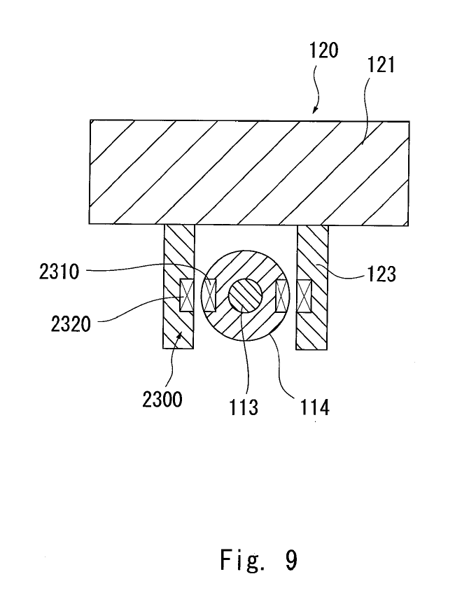

Although the movable part 114 and the sliding part 120 are magnetically joined to each other by using only one magnetic joint in the first and second exemplary embodiments, the present invention is not limited to this configuration. That is, as shown in FIGS. 8 and 9, magnetic joints 2300 are preferably arranged on both sides of the ball screw nut 113. Similarly to the second exemplary embodiment, each of the magnetic joints 2300 includes a magnetic member 2310 and a member 2320 made of iron or the like. The magnetic members 2310 are arranged in the outer circumferential portion of the movable part 114 so as to sandwich the ball screw nut 113 therebetween. That is, magnetic members 2310 are disposed in a point-symmetrical arrangement with respect to the center of the ball screw nut 113. The sliding part 120 includes side-wall parts 123 that cover the ball screw nut 113 from the sides. The side-wall parts 123 protrude from the side of the base part 121 located on the movable part 114 side. The members 2320 made of iron or the like are disposed roughly at the center in the vertical direction of the side-wall parts 123. With the configuration like this, the movable part 114 supports the sliding part 120 from the portions located on both sides of the ball screw nut 113. Therefore, it is possible to roughly cancel out the forces that would otherwise cause the movable part 114 to move toward the sliding part 120 side due to the joining force of the magnetic joint, and thereby to reduce the frictional wear of the ball screw nut 113.

### Fourth Exemplary Embodiment

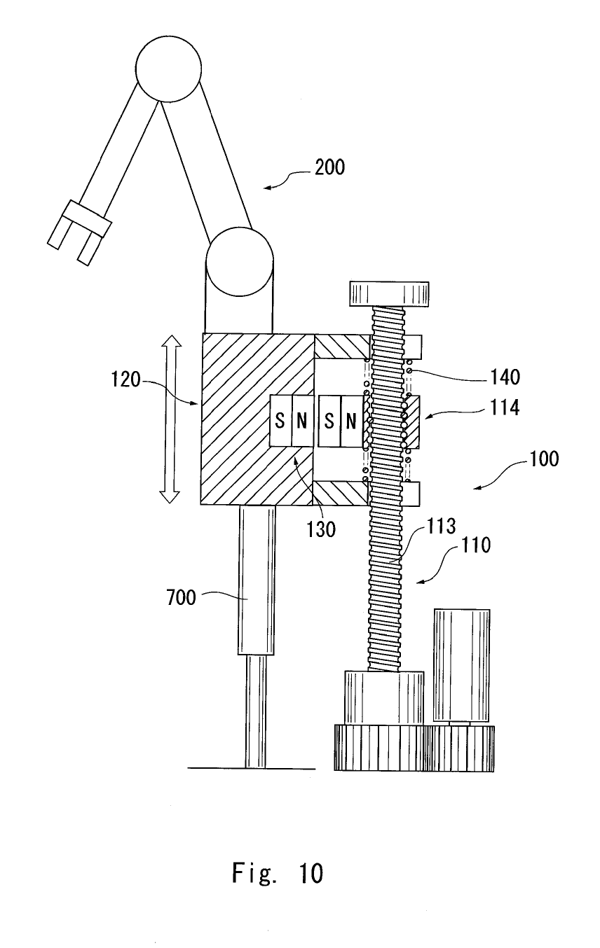

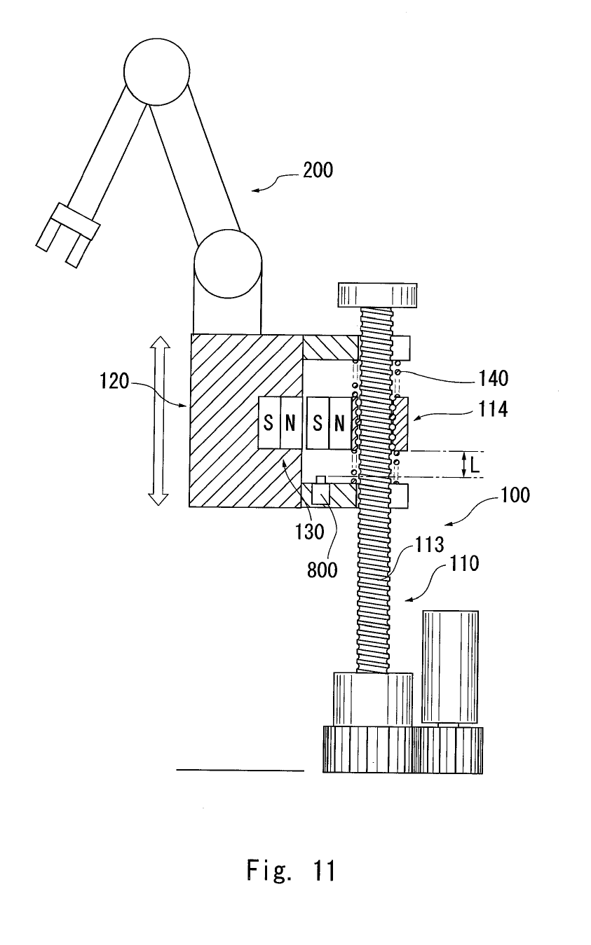

Although the sliding part 120 is supported by the magnetic joint alone in the first to third exemplary embodiments, the present invention is not limited to this configuration. That is, as shown in FIG. 10, the sliding part 120 is preferably supported by an assist mechanism 700 such as a gas spring, a gas balancer, and an air cylinder from the bottom of the sliding part 120. With the configuration like this, the burden on the magnetic joint can be reduced, and therefore the size of the magnetic joint can be reduced.

### Fifth Exemplary Embodiment

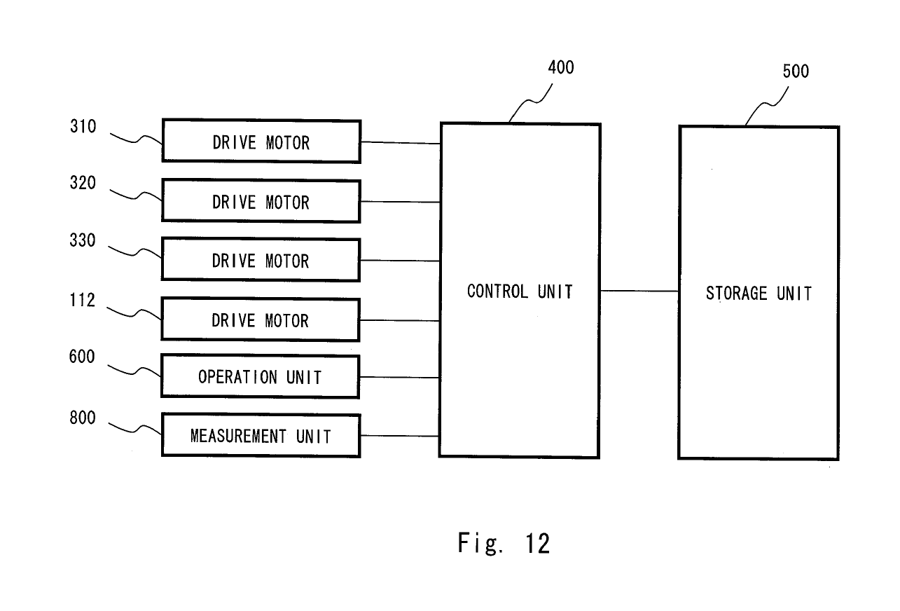

Although the first to fourth exemplary embodiments do not adopt such a configuration that the operation of the drive motor 112 is controlled when the displacement of the sliding part 120 with respect to the movable part 114 becomes larger, the present invention is not limited to such configurations. That is, as shown in FIGS. 11 and 12, it is preferable to adopt such a configuration that the drive motor 112 is controlled based on the vertical distance L between the movable part 114 and the sliding part 120. Specifically, in addition to the above-described components, the linear motion mechanism 100 may include a measurement unit 800 such as a range sensor. The measurement unit 800 measures a vertical distance L between the movable part 114 and the sliding part 120. For example, the measurement unit 800 is disposed on the top surface of the lower reaction force transmission part 122 in the sliding part 120. The measurement unit 800 measures a distance between the bottom surface of the movable part 114 and the upper surface of the lower reaction force transmission part 122 in the sliding part 120. The measurement unit 800 outputs the measured measurement value to the control unit 400. The control unit 400 subtracts the input measurement value from a predefined distance between the bottom surface of the movable part 114 and the upper surface of the lower reaction force transmission part 122 in the sliding part 120 to calculate the displacement of the sliding part 120 with respect to the movable part 114. Then, when the calculated displacement is equal to or greater than a predetermined threshold, the control unit 400 stops the operation of the drive motor 112. In short, the load exerted on the sliding part 120 can be associated with the distance L between the movable part 114 and the sliding part 120. Therefore, it is possible to determine that when the displacement is large, a large load is exerted on the sliding part 120. Therefore, in this exemplary embodiment, when a large load is exerted on the sliding part 120, the operation of the drive motor 112 is suspended so that the joint relation with the movable part 114 is not disengaged due to the large load. With the configuration like this, the joint relation between the movable part 114 and the sliding part 120 will not be easily disengaged.

Note that the present invention is not limited to the above-described exemplary embodiments, and various modifications can be made without departing from the spirit of the present invention. For example, although the ball screw nut 113 is engaged with the female thread part 1141 of the movable part 114 through a bearing so that the drive mechanism 110 can transmit the rotational driving force in the above-described exemplary embodiments, the present invention is not limited to this configuration. That is, a rack may be used as a substitute for the ball screw nut 113. By engaging the rack with a pinion gear provided on the rotation shaft of the drive motor mounted on the movable part 114, the movable part 114 can be vertically moved. In short, any configurations in which the movable part 114 can be moved in one axis direction can be employed.

Although the movable part 114 of the linear motion mechanism 100 is disposed so as to move in the vertically direction in the above-described exemplary embodiments, the movable part 114 may be disposed so as to move in the horizontal direction.

Although the robot arm 200 is attached to the linear motion mechanism 100 in the above-described exemplary embodiments, the use of the linear motion mechanism 100 is not limited to any particular uses.

Although the linear rails are used as the restraint mechanism 150 in the above-described exemplary embodiments, in short, any configurations in which the rotation of the sliding part 120 around the axis of the ball screw nut 113 can be restrained can be employed.

### INDUSTRIAL APPLICABILITY

A linear motion mechanism and a robot in accordance with the present invention can be used as a linear motion mechanism and a robot in which when a magnetic joint is disengaged, the joint relation of the magnetic joint can be easily restored.

### REFERENCE SIGNS LIST

100 LINEAR MOTION MECHANISM
110 DRIVE MECHANISM
111 PEDESTAL
112 DRIVE MOTOR
113 BALL SCREW NUT
114 MOVABLE PART
1141 FEMALE THREAD PART
120 SLIDING PART
121 BASE PART
122 REACTION FORCE TRANSMISSION PART
1221 CUT-OUT PORTION
123 SIDE-WALL PART
130 MAGNETIC JOINT
131 FIRST MAGNETIC MEMBER
132 SECOND MAGNETIC MEMBER
140 RESTORATION MEMBER
150 RESTRAINT MECHANISM
151 SUPPORT COLUMN
152 LINEAR RAIL
1521 RAIL
1522 SLIDER
200 ROBOT ARM
210 ARM PART
211 FIRST ARM
212 SECOND ARM
213 THIRD ARM
220 HAND PART
310 DRIVE MOTOR
400 CONTROL UNIT
500 STORAGE UNIT
600 OPERATION UNIT
700 ASSIST MECHANISM
800 MEASUREMENT UNIT
1300 MAGNETIC JOINT
1310 MAGNETIC MEMBER
1320 MEMBER MADE OF IRON OR THE LIKE
2300 MAGNETIC JOINT
2320 MEMBER MADE OF IRON OR THE LIKE

1. A linear motion mechanism comprising:
a movable part that receives a reaction force from a guild disposed in one axis direction, and moves along the guide;
a drive unit that serves as a driving source of the movable part;
a sliding part that slides along the guides;
a magnetic joint that magnetically joins the movable part to the sliding part; and
a restoration member that restores, separately from the drive unit, a joint relation between the movable part and the sliding part.

2. The linear motion mechanism according to claim 1, wherein
a reaction force transmission part is formed in the sliding part with a space in the one axis direction,
the movable part is disposed in the space portion of the reaction force transmission part, and
the restoration member is disposed between the reaction force transmission part and the movable part.

3. The linear motion mechanism according to claim 1, further comprising a restraint mechanism that restrains a rotation of the sliding part around an axis of the guide.

4. The linear motion mechanism according to claim 1, wherein
as the magnetic joint, a magnet is provided in one of the movable part and the sliding part and a member that is magnetically attracted by the magnet is provided in the other of the movable part and the sliding part, and
the magnet and the member that is magnetically attracted by the magnet are disposed so as to be opposed to each other.

5. The linear motion mechanism according to claim 1, wherein the magnetic joint is disposed on both sides of the guide.

6. The linear motion mechanism according to claim 1, further comprising an assist mechanism that assists the joint relation between the movable part and the sliding part.

7. The linear motion mechanism according to claim 1, further comprising:
a measurement unit that measures a distance in the one axis direction between the movable part and the sliding part; and
a control unit that receives a measurement value of the measurement unit, calculates a displacement of the sliding part with respect to the movable part, and when the calculated displacement is equal to or greater than a threshold, stops a movement of the movable part.

8. A robot comprising a linear motion mechanism according to claim 1.
